(19) United States
(12) Patent Application Publication
(10) Pub. No.: US 2010/0066957 A1
(43) Pub. Date: Mar. 18, 2010

(54) LIQUID CRYSTAL DISPLAY DEVICE

(76) Inventors: Shinichi Miyazaki, Osaka-shi (JP); Kenji Misono, Osaka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/518,525

(22) PCT Filed: Dec. 10, 2007
(86) PCT No.: PCT/JP2007/073789

§ 371 Date: Jun. 10, 2009

(30) Foreign Application Priority Data
Dec. 11, 2006 (JP) 2006-332809

(51) Int. Cl. G02F 1/1335

(52) U.S. Cl. 349/112

(57) ABSTRACT

Blurriness of display in a liquid crystal display device having a light diffuser is suppressed.

A liquid crystal display device according to the present invention includes a light source, a liquid crystal display panel for modulating light emitted from the light source, and a light diffuser being disposed at a viewer's side of the liquid crystal display panel and diffusing light traveling through the liquid crystal display panel. The liquid crystal display panel includes a color filter, and the light diffuser is disposed so that a distance d between the color filter and the light diffuser, a pixel pitch p of the liquid crystal display panel, and a display surface luminance L satisfy the relationship d/p<12.151L^{-0.3186}.

### TECHNICAL FIELD

The present invention relates to a liquid crystal display device, and in particular to a liquid crystal display device including a light diffuser for diffusing light going out from a liquid crystal display panel.

### BACKGROUND ART

In recent years, portable electronic devices such as mobile phones and PDAs (Personal Digital Assistants) are in wide use. In a display section of a portable electronic device, a liquid crystal display device is frequently used because of its advantages in terms of thinness, light weight, and low power consumption.

In a liquid crystal display device, the display element itself does not emit light, unlike self-light-emitting type display devices such as CRTs and PDPs (plasma display panels). Therefore, in a transmission-type liquid crystal display device, an illuminator called a backlight is provided at the rear face side of the liquid crystal display element, and an image is displayed as the transmitted amount of the illumination light from this backlight is controlled by the liquid crystal display element in a pixel-by-pixel manner.

Liquid crystal display devices of various methods are known. However, some methods (e.g., methods using a TN type or STN type liquid crystal display element) have a disadvantage of narrow viewing angles, and various techniques are under development for overcoming this disadvantage.

As a representative technique for improving the viewing angle characteristics of a liquid crystal display device, there is a method of adding an optical compensation plate. There is also known a method of enhancing the directivity (degree of parallelism) of light which is emitted from a backlight before the light enters a liquid crystal display element, and allowing the light having traveled through the liquid crystal display element to be diffused by a lenticular lens sheet which is disposed on the front face of the liquid crystal display element (e.g., Patent Document 1).

FIG. 12 shows a liquid crystal display device 500 which is disclosed in Patent Document 1. The liquid crystal display device 500 includes a liquid crystal display panel 520, a backlight 510 disposed at the rear face side of the liquid crystal display panel 520, and a lenticular lens sheet 530 disposed at a viewer's side of the liquid crystal display panel 520.

The backlight 510 includes a light source 501 and a light guide plate 502 for guiding the light having been emitted from the light source 501 to the liquid crystal display panel 520. The light guide plate 502 has an outgoing face 502a through which light goes out toward the liquid crystal display panel 520 and a rear face 502b opposing the outgoing face 502a. A plurality of prisms 503 are provided on the rear face 502b.

While propagating within the light guide plate 502, the light having been emitted from the light source 501 is reflected toward the liquid crystal display panel 520 by the prisms 503 on the rear face, so as to go out through the outgoing face 502a. Each prism 503 has two slopes that are slanted at respectively difference predetermined angles with respect to the outgoing face 502a, so that the light which is emitted from the backlight 510 has a very strong intensity along the display surface normal direction (frontal direction). In other words, a high directivity is imparted to the light emitted from the backlight 510.

Since the liquid crystal display panel 520 is designed so that light entering parallel to the display surface normal direction has the highest contrast ratio, it is possible to obtain an improved contrast ratio by allowing the aforementioned high-directivity light to enter the liquid crystal display panel 520. Moreover, the light having traveled through the liquid crystal display panel 520 is diffused by the lenticular lens sheet 530, whereby the viewing angle is broadened. In this manner, with the liquid crystal display device 500, both a high contrast ratio and wide viewing angle characteristics are realized.

[Patent Document 1] Japanese Laid-Open Patent Publication No. 9-22011

### DISCLOSURE OF INVENTION

### Problems to be Solved by the Invention

However, blurriness of display occurs in the liquid crystal display device 500 disclosed in Patent Document thus deteriorating the display quality. This blurriness of display occurs when light emitted from one pixel is mixed with light which is emitted from another pixel and diffused by the lenticular lens sheet 530 (which is a light diffuser), which causes an intermixing of colors and deteriorates the displayed image.

The present invention has been made in view of the aforementioned problems, and an objective thereof is to suppress blurriness of display in a liquid crystal display device having a light diffuser.

### Means for Solving the Problems

A liquid crystal display device according to the present invention is a liquid crystal display device comprising: a light source; a liquid crystal display panel for modulating light emitted from the light source; and a light diffuser being disposed at a viewer's side of the liquid crystal display panel and diffusing light traveling through the liquid crystal display panel, wherein, the liquid crystal display panel includes a color filter; and the light diffuser is disposed so that a distance d between the color filter and the light diffuser, a pixel pitch p of the liquid crystal display panel, and a display surface luminance L satisfy the relationship d/p<12.151L^{-0.3186}.

In a preferred embodiment, the light diffuser is disposed so that the distance d, the pixel pitch p, and the display surface luminance L satisfy the relationship d/p<11.267L^{-0.3156}.

In a preferred embodiment, the light diffuser is disposed so that the distance d, the pixel pitch p, and the display surface luminance L satisfy the relationship d/p<10.368L^{-0.3133}.

In a preferred embodiment, the light diffuser is disposed so that the distance d, the pixel pitch p, and the display surface luminance L satisfy the relationship d/p<9.1486L^{-0.3068}.

In a preferred embodiment, the light diffuser is disposed so that the distance d, the pixel pitch p, and the display surface luminance L satisfy the relationship d/p<7.2083L^{-0.2848}.

In a preferred embodiment, the light diffuser is disposed so that the distance d, the pixel pitch p, and the display surface luminance L satisfy the relationship d/p<3.8036L^{-0.2003}.

In a preferred embodiment, the liquid crystal display device according to the present invention comprises an illuminator which includes the light source.

In a preferred embodiment, the illuminator has an intensity distribution such that a luminance in directions at an angle of 30° or more with respect to a display surface normal direction is 13% or less of a luminance in the display surface normal direction.

In a preferred embodiment, the illuminator has an intensity distribution such that a luminance in directions at an angle of 30° or more with respect to a display surface normal direction is 3% or less of a luminance in the display surface normal direction.

In a preferred embodiment, the illuminator includes a directivity controlling element for controlling directivity of light emitted from the light source.

### EFFECTS OF THE INVENTION

A light diffuser of a liquid crystal display device according to the present invention is disposed so that a distance d between a color filter and a light diffuser, a pixel pitch p of a liquid crystal display panel, and a display surface luminance L satisfy a predetermined relationship, whereby blurriness of display is suppressed.

### BRIEF DESCRIPTION OF DRAWINGS

FIG. 1 A cross-sectional view schematically showing a liquid crystal display device 100 according to a preferred embodiment of the present invention.

FIG. 2 A cross-sectional view showing an example of an illuminator (backlight) included in the liquid crystal display device 100.

FIG. 3 A diagram for explaining a function of a prism sheet included in the illuminator shown in FIG. 2.

FIG. 4 A cross-sectional view showing an example of a light diffuser included in the liquid crystal display device 100.

FIG. 5 A cross-sectional view showing another example of a light diffuser included in the liquid crystal display device 100.

FIG. 6 A cross-sectional view showing still another example of a light diffuser included in the liquid crystal display device 100.

FIG. 7 A diagram for explaining a relationship between a subject of viewing and an actual range of viewing, when an object is viewed via a light diffuser.

FIG. 8 A graph showing a relationship between d/p and a color difference ΔE*ab where a display surface luminance L is varied.

FIG. 9 A graph in which values of d/p which make ΔE*ab=3.0 in FIG. 8 are plotted against the horizontal axis representing the display surface luminance L and the vertical axis representing d/p.

FIG. 10 A graph in which values of d/p which make ΔE*ab=2.5, 2.0, 1.5, 1.0, 0.5 in FIG. 8 are plotted against the horizontal axis representing the display surface luminance L and the vertical axis representing d/p.

FIGS. 11 (a), (b), and (c) are graphs showing exemplary intensity distributions of light emitted from an illuminator.

FIG. 12 A cross-sectional view schematically showing a conventional liquid crystal display device 500.

### DESCRIPTION OF REFERENCE NUMERALS

1 light source
2 light guide plate
3 prism sheet (directivity controlling element)
4 prism
10 illuminator (backlight)
20 liquid crystal display panel
21 rear substrate
22 front substrate
23 liquid crystal layer
24 color filter
30 light diffuser
30A lens sheet (light diffuser)
30B prism sheet (light diffuser)
30C diffusion film (light diffuser)
31 lens
32 prism
33 matrix
34 particles
40a, 40b phase difference compensation element
50a, 50b polarizing plate
100 liquid crystal display device

### BEST MODE FOR CARRYING OUT THE INVENTION

Hereinafter, an embodiment of the present invention will be described with reference to the drawings. Note that the present invention is not limited to the following embodiment.

### Embodiment 1

FIG. 1 shows a liquid crystal display device 100 according to the present embodiment. The liquid crystal display device 100 includes a liquid crystal display panel 20, an illuminator (backlight) 10 disposed at a rear face side of the liquid crystal display panel 20, and a light diffuser 30 disposed at a viewer's side of the liquid crystal display panel 20.

The liquid crystal display panel 20 includes a pair of substrates 21 and 22, and a liquid crystal layer 23 provided therebetween. On surfaces of the substrates 21 and facing the liquid crystal layer 23, electrodes for applying voltages across the liquid crystal layer 23 and alignment films for defining the orientation directions of liquid crystal molecules contained in the liquid crystal layer 23 (neither of them is shown) are formed. Moreover, a color filter 24 is provided on the liquid crystal layer 23 side of the substrate 22 which is disposed at the viewer's side (i.e., between the substrate 22 at the viewer's side and the liquid crystal layer 23).

At the viewer's side of the liquid crystal display panel 20, a phase difference compensation element 40a and a polarizing plate 50a are provided. Also at the rear face side of the liquid crystal display panel 20, a phase difference compensation element 40b and a polarizing plate 50b are provided. Various known phase difference plates may be used as the phase difference compensation elements 40a and 40b. Note that the number and placement of the phase difference compensation elements are not limited to what is exemplified herein. Three or more phase difference compensation elements may be provided, or only one phase difference compensation element may be provided between either one of the polarizing plates 50a and 50b and the liquid crystal display panel 20. The light diffuser 30 is disposed between the phase difference compensation element 40a at the viewer's side and the liquid crystal display panel 20.

The illuminator 10 at least includes a light source. Light which is emitted from the illuminator 10 of the present embodiment has a significantly strong intensity in the display surface normal direction (frontal direction). In other words, a high directivity is imparted to the light emitted from the illuminator 10.

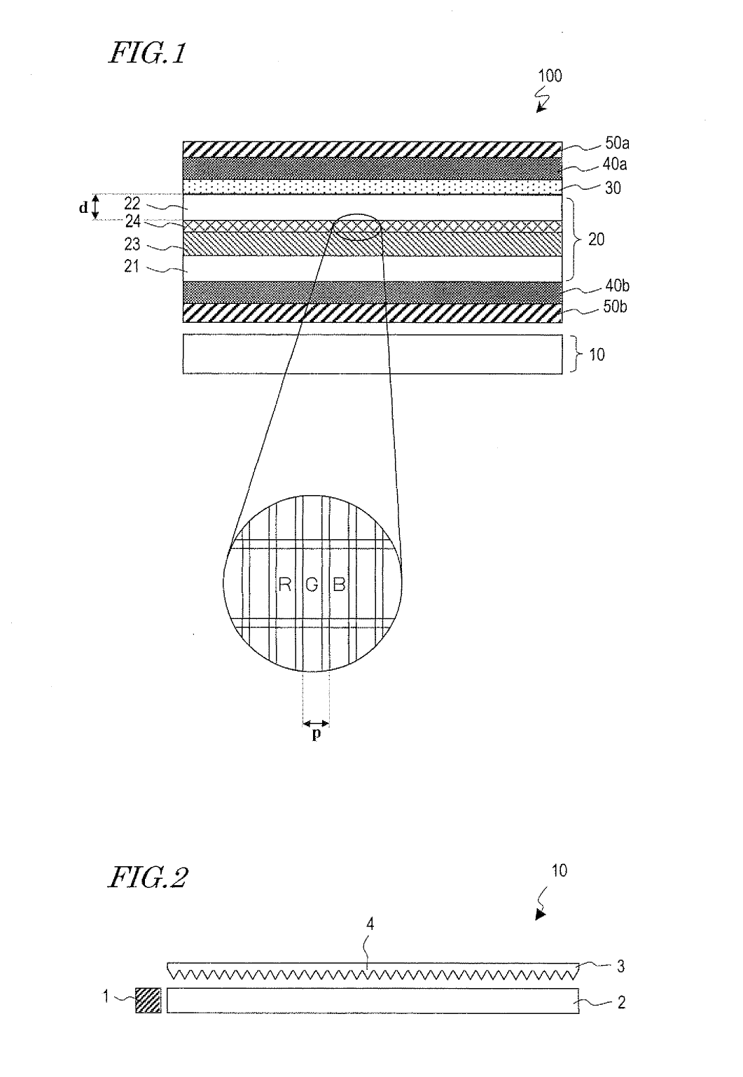

FIG. 2 shows an exemplary specific construction of the illuminator 10. The illuminator 10 shown in FIG. 2 includes a light source 1 and a light guide plate 2 for guiding the light emitted from the light source 1 toward the liquid crystal display panel 20. The light source 1 is a light-emitting diode (LED) or a cold-cathode tube, for example. In the light guide plate 2, structures for allowing light which has been emitted from the light source 1 and entered into the light guide plate 2 to go out toward the liquid crystal display panel 20 are formed. For example, on at least one of the two principal faces of the light guide plate 2, prism or grain is formed.

Furthermore, the illuminator 10 includes a prism sheet 3 for controlling the directivity of light going out from the light guide plate 2. The prism sheet 3 functioning as a directivity controlling element is provided between the light guide plate 2 and the liquid crystal display panel 20.

The prism sheet 3 includes a plurality of prisms 4 formed on its principal face closer to the light guide plate 2, and as shown in FIG. 3, directs the light going out from the light guide plate 2 in the display surface normal direction by utilizing a total reflection phenomenon. Thus, the prism sheet 3 imparts a high directivity to the light going out from the light guide plate 2.

When the light emitted from the illuminator 10 has a high directivity, light traveling through the liquid crystal layer 23 can be substantially uniformly modulated (i.e., a substantially uniform retardation can be imparted to the light traveling through the liquid crystal layer 23), whereby the viewing angle dependence of display quality associated with the refractive index anisotropy of the liquid crystal molecules can be reduced. As it is, the light having traveled through the liquid crystal layer 23 has a high directivity and a large imbalance in luminance (that is, a very high luminance exists along the display surface normal direction whereas luminances along oblique directions are low). However, through diffusion by the light diffuser 30, the luminance imbalance is reduced, whereby the viewing angle is broadened.

As the light diffuser 30, various devices having a function of diffusing light can be used. The light diffusers 30 may be a lens sheet 30A having a plurality of lenses 31 as shown in FIG. 4, or a prism sheet 30B having a plurality of prisms 32 as shown in FIG. 5, for example. The lens sheet 30A and the prism sheet 30B diffuse light by utilizing a refraction action or total reflection phenomenon at the lenses 31 or prisms 32.

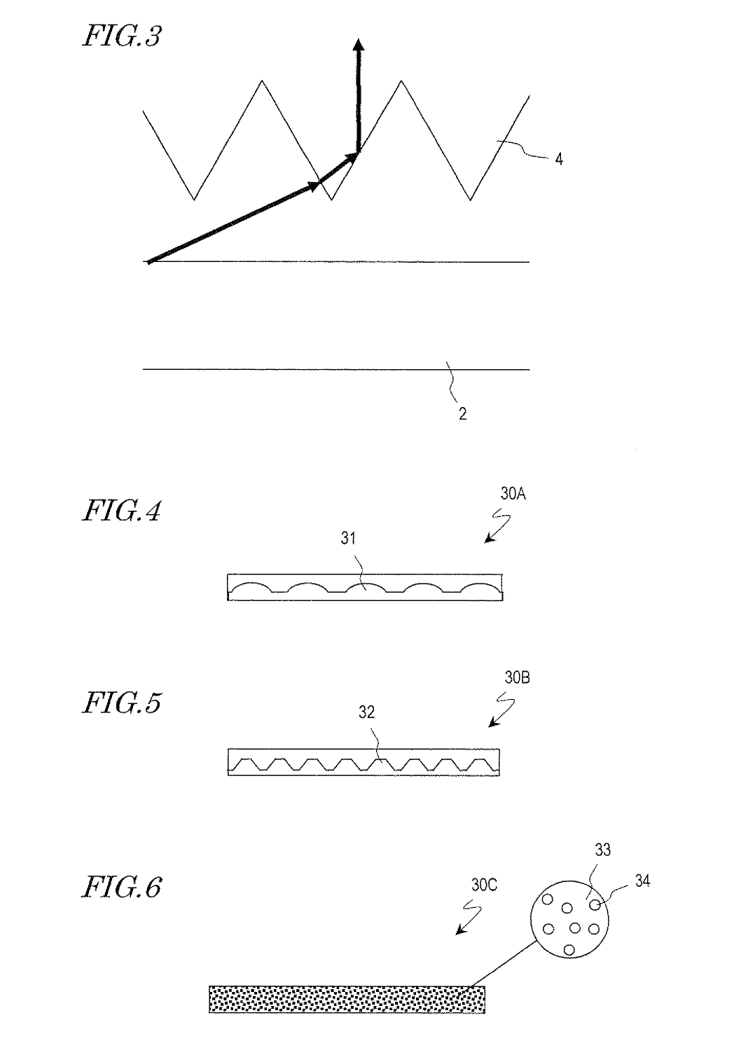

Alternatively, the light diffuser 30 may be a diffusion film 30C which utilizes internal scatter, as illustrated in FIG. 6. As shown partly enlarged in FIG. 6, the diffusion film 30C (which may also be referred to as a “diffuser”) includes a matrix 33 made of a resin material, and particles 34 which are dispersed in the matrix 33 and have a refractive index different from the refractive index of the matrix 33. The diffusion film 30C diffuses light by utilizing a scatter phenomenon due to the difference in refractive index between the matrix 33 and the particles 34. Moreover, the lens sheet 30A or the prism sheet 30B may be used in combination with the diffusion film 30C.

The light diffuser 30 of the present embodiment is disposed so that a distance d between the color filter 24 and the light diffuser 30, a pixel pitch p of the liquid crystal display panel 20, and a display surface luminance L satisfy the relationship of eq. (1) below.

d/p<12.151L^{-0.3186} (1)

Note that the distance d between the color filter 24 and the light diffuser 30 as mentioned herein is, strictly speaking, the interval between a surface of the color filter 24 closer to the viewer's side and a surface of the light diffuser 30 closer to the rear face side (opposite from the viewer's side), as is also shown in FIG. 1. The pixel pitch p means the smallest pitch among a number of pitches that may exist, as shown in a partially enlarged view of the color filter 24 in FIG. 1. The display surface luminance L is a luminance when all of the pixels are placed in a white displaying (displaying the highest gray scale level) state.

By disposing the light diffuser 30 so that the distance d, the pixel pitch p, and the display surface luminance L satisfy the relationship of eq. (1) above, a high-quality displaying with suppress blurriness of display can be performed. Hereinafter, the reason behind this will be specifically described.

“Blurriness of display” is a phenomenon where irrelevant light is mixed into light (an image) that is meant to be visually perceived, thus causing an intermixing of colors and rendering the image unclear. Therefore, the level of blurriness of display can be expressed by, with respect a given pixel, using a color difference when the luminance of the surrounding pixels is changed, and can be expressed as a color difference ΔE*ab in the L*ab (CIE1976) color system, for example. The color difference ΔE*ab can be measured according to JIS 28729. Table 1 below shows a specific correspondence between values of ΔE*ab and emotive expressions of vision. As can also be seen from Table 1, by ensuring that the color difference ΔE*ab is less than 3.0, a displaying is realized in which blurriness of display is suppressed and which is free of awkwardness.

TABLE 1

| emotive expression of vision | ΔE*ab |
|---|---|
| trace color difference | 0-0.5 |
| slight color difference | 0.5-1.5 |
| noticeable color difference | 1.5-3.0 |
| appreciable color difference | 3.0-6.0 |
| much color difference | 6.0-12.0 |
| very much color difference | 12.0- |

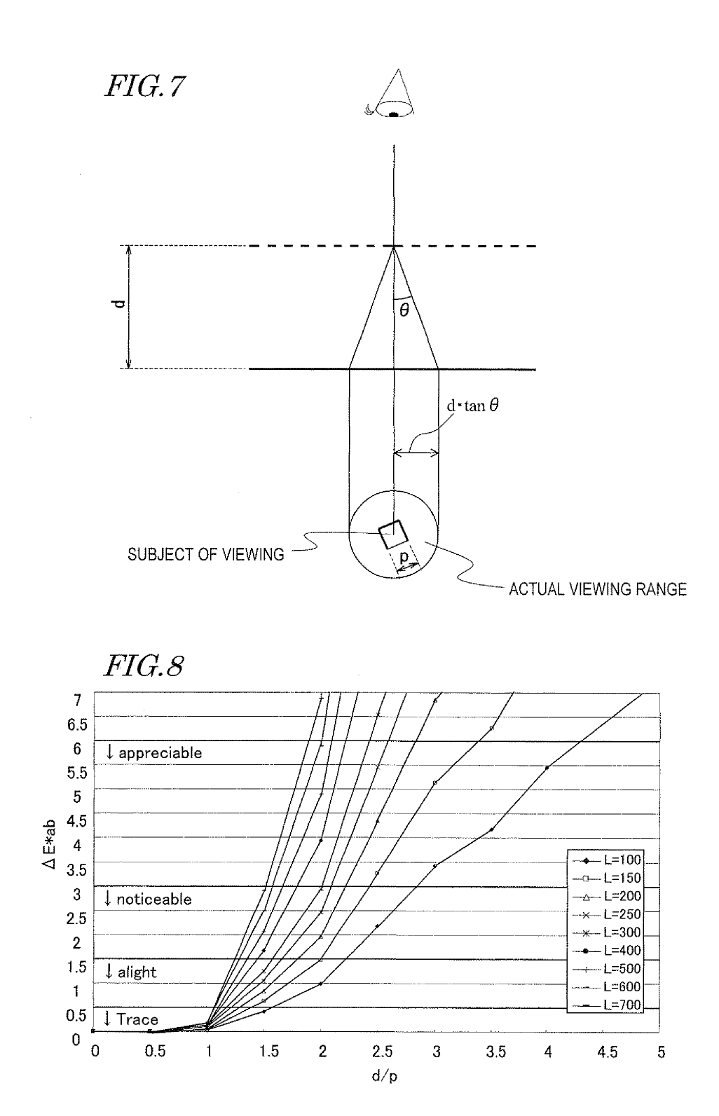

According to detailed studies of the inventors, it has been found that a blurriness of display which is expressed as a color difference ΔE*ab can be evaluated by using a ratio d/p between the distance d and the pixel pitch p as a parameter. In the case where an object is viewed through a light diffuser, the viewer will be viewing light from a range which is larger than the subject of viewing, as shown in FIG. 7. Therefore, the level of blurriness of display depends on the proportion which the subject of viewing occupies within the actual viewing range. Assuming that the diffuse angle of the light diffuser is θ; the distance between the light diffuser and the subject of viewing is d; and the length of one side of the subject of viewing is p, then the area of the actual viewing range is π·(d·tan θ)²=πd² tan² θ, whereas the area of the subject of viewing is p². Therefore, the proportion which is occupied by the subject of viewing within the viewing range is p²/(πd² tan² θ)=(p/d)²·(1/π tan² θ).

Since the above discussion straightforwardly applies to any pixel that is distant from the light diffuser by the distance d, the blurriness of display can be evaluated by using the ratio d/p between the distance d and the pixel pitch p (which is an inverse of p/d) as a parameter.

Moreover, a blurriness of display which is expressed as a color difference ΔE*ab can also be evaluated by using the display surface luminance L as a parameter. FIG. 8 shows a relationship between d/p and the color difference ΔE*ab where the display surface luminance (cd/m²) is varied. Note that FIG. 8 shows a color difference ΔE*ab which is measured with respect to a red pixel between a black displaying state and a cyan displaying state. In a black displaying state, all of the red pixel, the green pixel, and the blue pixel in a picture element are at the lowest luminance, whereas in a cyan displaying state, the red pixel is at the lowest luminance but the green pixel and the blue pixel are at the highest luminance. As the measurement equipment, a high-sensitivity microspectrography unit TFCAM-7000C manufactured by Lambda Vision, inc. was used for the measurements. The measurements were taken under conditions where a 10× lens was used as an objective lens and an illuminator 10 including X-BEF (manufactured by Sumitomo 3M Limited) as the directivity controlling element 3 was used.

As can be seen from FIG. 8, given the same d/p, the color difference ΔE*ab increases as the display surface luminance L increases. Therefore, the blurriness of display can be evaluated also by using the display surface luminance L as a parameter. It can also be seen from FIG. 8 that, given the same display surface luminance L, the color difference ΔE*ab increases as d/p increases.

FIG. 9 shows values of d/p which make ΔE*ab=3.0 in FIG. 8, being plotted against the horizontal axis representing the display surface luminance L and the vertical axis representing d/p. FIG. 9 also shows a curve C1 which is a power approximation of the plotted d/p values. This curve C1 is expressed by eq. (2) below.

d/p=12.151L^{-0.3186} (2)

in the graph of FIG. 9, if a point which is defined by d/p and ΔE*ab is located below the curve C1, ΔE*ab is less than 3.0. Therefore, if the ratio d/p between the distance d and the pixel pitch p and the display surface luminance L satisfy the already-described relationship eq. (1) (which corresponds to eq. (2) where the equal sign has been replaced with an inequality sign), it can be ensured that ΔE*ab is less than 3.0, so that the blurriness of display can be sufficiently suppressed.

Note that, when measuring the color difference ΔE*ab shown in FIG. 8 and FIG. 9, a cyan displaying state was selected as one state for measurement. This is because the color difference ΔE*ab will be larger when a cyan displaying state is selected than when a state of displaying any other color is selected. Table 2 below shows values of color difference ΔE*ab when a cyan displaying state (where only the red pixel is at the lowest luminance), a magenta displaying state (where only the green pixel is at the lowest luminance), or a yellow displaying state (where only the blue pixel is at the lowest luminance) is selected (d/p=5.25). As can also be seen from Table 2, when a cyan displaying state is selected, the color difference ΔE*ab is larger than when a magenta displaying state or a yellow displaying state is selected.

TABLE 2

| | cyan | magenta | yellow |
|---|---|---|---|
| ΔE*ab | 20.66 | 8.93 | 7.28 |

Moreover, when measuring the color difference ΔE*ab shown in FIG. 8 and FIG. 9, the measurements were taken in a state where cyan was displayed in a stripe pattern. This is because the color difference ΔE*ab will become large by displaying such a pattern. Table 3 below shows values of color difference ΔE*ab in the case where measurements are taken in a state of displaying cyan in a stripe pattern (a state where the picture elements surrounding the picture element containing the pixel for evaluation are also displaying cyan), and in the case where the measurements are taken in a state of displaying cyan in a dot pattern (a state where the surrounding picture elements are displaying white). As can also be seen from Table 3, when cyan is displayed in a stripe pattern, the color difference ΔE*ab is larger than when cyan is displayed in a dot pattern.

TABLE 3

| | |
|---|---|
| picture element containing | cyan displaying |

| pixel for evaluation | cyan | white |
|---|---|---|
| surrounding picture elements | displaying | displaying |
| ΔE*ab | 20.66 | 15.12 |

As described above, when measuring the color difference ΔE*ab shown in FIG. 8 and FIG. 9, the measurements were taken under conditions which would maximize the color difference ΔE*ab, i.e., conditions under which blurriness of display was most likely to occur. Therefore, by disposing the light diffuser 30 so as to fit below the curve C1 shown in FIG. 9 (i.e., so that d/p and L satisfy the relationship of eq. (1)), blurriness of display can be sufficiently suppressed.

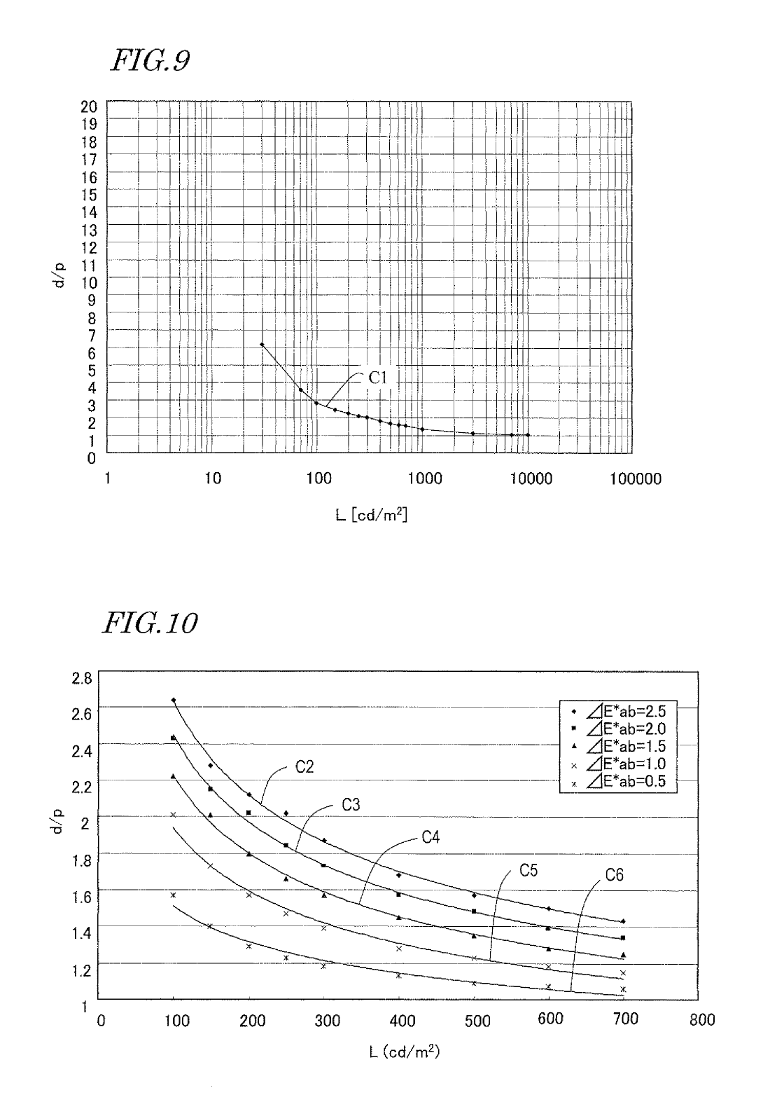

Note that, in order to further suppress blurriness of display, it is preferable to dispose the light diffuser 30 so that the color difference ΔE*ab becomes even smaller. FIG. 10 shows values of d/p which make ΔE*ab=2.5, 2.0, 1.5, 1.0, 0.5. FIG. 10 also shows curves C2, C3, C4, C5, and C6 which are power approximations of the Illustrated d/p values with respect to ΔE*ab=2.5, 2.0, 1.5, 1.0, and 0.5, respectively. These curves C2, C3, C4, C5, and C6 are expressed by eqs. (3), (4), (5), (6), and (7) below.

d/p=11.267L^{-0.3156} (3)

d/p=10.368L^{-0.3133} (4)

d/p=9.1486L^{-0.3068} (5)

d/p=7.2083L^{-0.2848} (6)

d/p=3.8036L^{-0.2003} (7)

Therefore, by disposing the light diffuser 30 so that each point which is defined by d/p and L is located below the curve C2, C3, C4, C5, or C6, i.e., by disposing the light diffuser 30 so that d/p and L satisfy the relationship of eq. (8), (9), (10), (11), or (12) below, it can be ensured that the color difference ΔE*ab is less than 2.5, less than 2.0, less than 1.5, less than 1.0, or less than 0.5, whereby blurriness of display can be further suppressed.

d/p<11.267L^{-0.3156} (8)

d/p<10.368L^{-0.3133} (9)

d/p<9.1486L^{-0.3068} (10)

d/p<7.2083L^{-0.2848} (11)

d/p<3.8036L^{-0.2003} (12)

Note that, as is also shown in FIG. 1, the light diffuser 30 is preferably disposed outside the liquid crystal display panel 20. When the light diffuser 30 is disposed outside the liquid crystal display panel 20, the light diffuser 30 can be formed less expensively than in the case where it is disposed inside the liquid crystal display panel (e.g., between the substrate 22 at the viewer's side and the color filter 24). An additional advantage will be that broader choices of the material of the light diffuser 30 become possible.

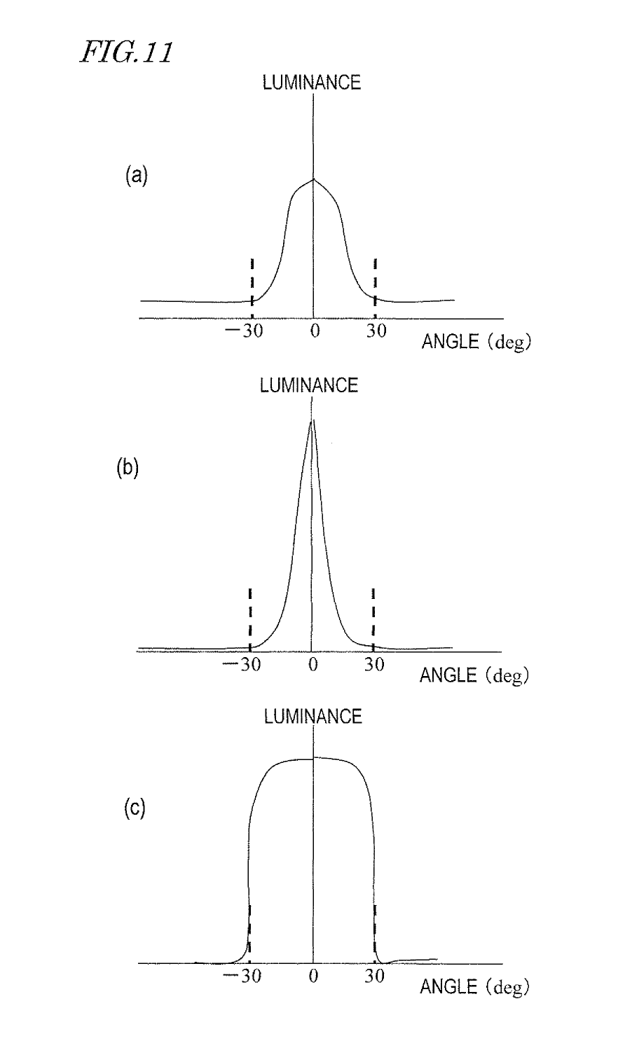

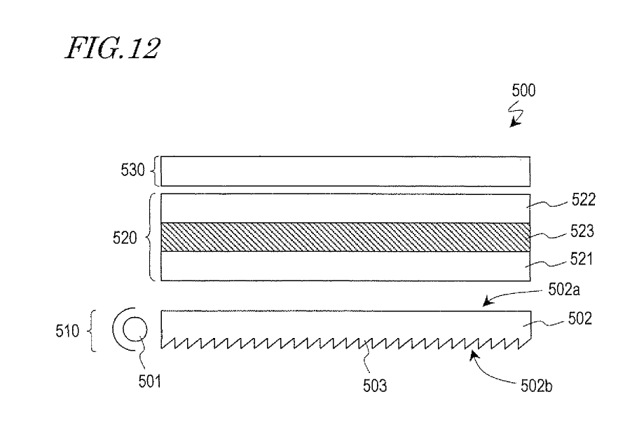

Moreover, without limitation to what is exemplified in FIG. 2, various backlights can be used as the illuminator 10. However, in order to obtain a higher contrast ratio, it is preferable to use that which is able to emit light with a higher directivity. Specifically, the illuminator 10 preferably has an intensity distribution such that the luminance in directions at an angle of 30° or more with respect to the display surface normal direction is 13% or less, and more preferably 3% or less, of the luminance in the display surface normal direction. FIGS. 11(a), (b), and (c) show preferable examples of intensity distribution of the illuminator 10.

In the intensity distribution shown in FIG. 11(a), the luminance in directions at an angle of 30° or more with respect to the display surface normal direction is equal to or less than 8% to 13% of the luminance in the display surface normal direction (0°). By using illuminators 10 having such intensity distributions, a more excellent display quality can be obtained.

Moreover, in the intensity distributions shown in FIGS. 11(b) and (c), the luminance in directions at an angle of 30° or more with respect to the display surface normal direction is 3% or less of the luminance in the display surface normal direction (0°). By using illuminators 10 having such intensity distributions, an even more excellent display quality can be obtained.

The level of directivity shown in FIG. 11(a) can be easily realized by using an illuminator 10 having the total-reflection type prism sheet 3 shown in FIG. 2, for example. The levels of directivity of FIGS. 11(b) and (c) can be realized by using the backlights disclosed in the specification of U.S. Pat. No. 5,949,933 and in the specification of U.S. Pat. No. 5,598,281. The specification of U.S. Pat. No. 5,949,933, supra, discloses an edge light type backlight, in which lenticular microprisms are provided on the principal face of a light guide plate. The specification of U.S. Pat. No. 5,598,281, supra, discloses a direct type backlight in which light having been emitted from a light source is allowed to enter microcollimators and microlenses via apertures.

### INDUSTRIAL APPLICABILITY

According to the present invention, the blurriness of display in a liquid crystal display device including a light diffuser can be suppressed, whereby a high quality displaying can be realized. The present invention is suitably used for liquid crystal display devices in general, and in particular, suitably used for liquid crystal display devices of display modes of poor viewing angle characteristics (e.g., STN mode, TN mode, ECB mode).

In display modes utilizing birefringence, e.g., the STN mode, there is a large unfavorable influence on displaying due to light which obliquely enters the liquid crystal layer, thus making it preferable to employ a viewing angle enlarging technique where highly directive light is allowed to enter a liquid crystal layer and light having been modulated by the liquid crystal layer is diffused by a light diffuser, thus leading to a large significance in applying the present invention.

1. A liquid crystal display device comprising:
a light source;
a liquid crystal display panel for modulating light emitted from the light source; and
a light diffuser being disposed at a viewer's side of the liquid crystal display panel and diffusing light traveling through the liquid crystal display panel, wherein,
the liquid crystal display panel includes a color filter; and
the light diffuser is disposed so that a distance d between the color filter and the light diffuser, a pixel pitch p of the liquid crystal display panel, and a display surface luminance L satisfy the relationship d/p<12.151L^{-0.3186}.

2. The liquid crystal display device of claim 1, wherein the light diffuser is disposed so that the distance d, the pixel pitch p, and the display surface luminance L satisfy the relationship d/p<11.267L^{-0.3156}.

3. The liquid crystal display device of claim 1, wherein the light diffuser is disposed so that the distance d, the pixel pitch p, and the display surface luminance L satisfy the relationship d/p<10.368L^{-0.3133}.

4. The liquid crystal display device of claim 1, wherein the light diffuser is disposed so that the distance d, the pixel pitch p, and the display surface luminance L satisfy the relationship d/p<9.1486L^{-0.3068}.

5. The liquid crystal display device of claim 1, wherein the light diffuser is disposed so that the distance d, the pixel pitch p, and the display surface luminance L satisfy the relationship d/p<7.2083L^{-0.2846}.

6. The liquid crystal display device of claim 1, wherein the light diffuser is disposed so that the distance d, the pixel pitch p, and the display surface luminance L satisfy the relationship d/p<3.8036L^{-0.2003}.

7. The liquid crystal display device of claim 1, comprising an illuminator which includes the light source.

8. The liquid crystal display device of claim 7, wherein the illuminator has an intensity distribution such that a luminance in directions at an angle of 30° or more with respect to a display surface normal direction is 13% or less of a luminance in the display surface normal direction.

9. The liquid crystal display device of claim 7, wherein the illuminator has an intensity distribution such that a luminance in directions at an angle of 30° or more with respect to a display surface normal direction is 3% or less of a luminance in the display surface normal direction.

10. The liquid crystal display device of claim 7, wherein the illuminator includes a directivity controlling element for controlling directivity of light emitted from the light source.
